(19) United States
(12) Patent Application Publication
(10) Pub. No.: US 2021/0079233 A1
(43) Pub. Date: Mar. 18, 2021

(54) POLYMERIC SURFACE REPAIRER AND PROTECTANT COMPOSITIONS

(71) Applicant: LEGACY INTERNATIONAL LIMITED, Dayton, OH (US)

(72) Inventors: Jamy CYRUS, Columbus, OH (US); Charles REITSMA, Dayton, OH (US)

(21) Appl. No.: 16/630,723

(22) PCT Filed: Jul. 13, 2018
(86) PCT No.: PCT/US2018/041991

§ 371 Date: Jan. 13, 2020

Related U.S. Application Data
(60) Provisional application No. 62/531,989, filed on Jul. 13, 2017.

(51) Int. Cl. C09D 7/20; C09D 191/00; C09D 175/04; C09D 133/06; C08J 7/02; C08J 7/04

(52) U.S. Cl. CPC C09D 7/20; C09D 191/00; C08J 7/0427; C09D 133/06; C08J 7/02; C09D 175/04

(57) ABSTRACT

The present disclosure provides a polymeric surface repairer and protectant composition for restoring faded and worn polymeric surfaces. In one example, the polymeric surface is a polymeric surface used in an automotive application. The polymeric surface repairer and protectant composition may clean the polymeric surface, etch the top layer of the polymeric surface, adhere to the etched polymeric surface, and become embedded in the polymeric surface once the polymeric surface hardens to produce a restored polymeric surface. The polymeric surface repairer and protectant composition may include a thinner component and a protective component. The polymeric surface repairer and protectant composition may further include an oil component. As an alternative to or in addition to the oil component, the polymeric surface repairer and protectant composition may include a drying component. In some embodiments, the polymeric surface repairer and protectant composition may further include a coloring component, a paint reducer component, a dispersant component, and/or a surfactant component.

### FIELD OF INVENTION

The present disclosure relates generally to compositions for improving the appearance of polymeric surfaces, more particularly to polymeric surface repairer and protectant compositions that clean, repair, recolor, and/or reseal polymeric surfaces to provide long lasting shine, coloring, and protection, methods for making the compositions, and methods of use for the compositions.

### BACKGROUND

Polymeric surfaces that are used in applications in which they are exposed to the environment (e.g., heat, cold, sun, dirt, debris, chemicals, debris, etc.) tend to fade or wear out over time. One exemplary application in which this occurs is in the automotive industry. Conventional products to improve the appearance of faded automotive polymeric surfaces are generally provided as liquids which are sprayed or otherwise applied onto the surface to be treated. However, conventional products, and the improved appearance they may provide, wear away after only a short period of time. There is a need in the market for a product that provides a long-lasting, improved appearance to automotive polymeric surfaces.

### SUMMARY

The present disclosure provides a polymeric surface repairer and protectant composition for restoring faded and worn polymeric surfaces. In one example, the polymeric surface is a polymeric surface used in an automotive application. The polymeric surface repairer and protectant composition may clean the polymeric surface, etch the top layer of the polymeric surface, adhere to the etched polymeric surface, and become embedded in the polymeric surface once the polymeric surface hardens to produce a restored polymeric surface. The polymeric surface repairer and protectant composition may include a thinner component and a protective component. The polymeric surface repairer and protectant composition may further include an oil component. As an alternative to or in addition to the oil component, the polymeric surface repairer and protectant composition may include a drying component. In some embodiments, the polymeric surface repairer and protectant composition may further include a coloring component, a paint reducer component, a dispersant component, and/or a surfactant component.

In accordance with one aspect of the present disclosure, a polymeric surface repairer and protectant composition comprises, by volume of the composition: 10% to 55% of at least one thinner component; 1% to 35% of at least one oil component; and 1% to 30% of at least one protective component.

In one embodiment, the at least one thinner component includes paint thinner.

In another embodiment, the at least one thinner component is present in the amount of 40% to 50% by volume of the composition.

In another embodiment, the at least one oil component includes boiled linseed oil.

In another embodiment, the at least one oil component is present in the amount of 25% to 35% by volume of the composition.

In another embodiment, the at least one protective component includes urethane.

In another embodiment, the at least one protective component is present in the amount of 20% to 30% by volume of the composition.

In another embodiment, the composition further includes 0.1% to 15% by volume of at least one coloring component.

In another embodiment, the at least one coloring component includes a mixture of liquid dye and vinegar.

In another embodiment, the at least one coloring component includes a mixture of powder dye and vinegar.

In another embodiment, the at least one coloring component is present in the amount of 0.1% to 10% by volume of the composition.

In another embodiment, the composition further includes 1% to 30% by volume of at least one paint reducer component.

In another embodiment, the composition further includes 0.1% to 50% by volume of at least one dispersant component.

In another embodiment, the composition further includes 0.1% to 5% by volume of at least one drying component.

In another embodiment, a method for repairing and protecting a polymeric surface includes: applying the composition of any one of claims 1 to 14 to the polymeric surface; and allowing the composition to dry for a period of 15 seconds to 24 hours.

In another embodiment, the polymeric surface is an automotive polymeric surface.

In another embodiment, the step of applying includes applying the composition to a cloth, pad, sponge, scrub, or foam brush, and using such on the polymeric surface.

In another embodiment, the polymeric surface includes polypropylene, high density polyethylene, polyvinyl chloride, low density polyethylene, polyurethane, polystyrene, acrylonitrile butadiene styrene, polybutylene terephthalate, polyoxymethylene, nylon, polyethylene terephthalate, polycarbonate, polyesters, or a mixture of two or more thereof.

In accordance with another aspect of the present disclosure, a polymeric surface repairer and protectant composition comprises, by volume of the composition: 1% to 25% of at least one thinner component; and 50% to 98% of at least one protective component.

In one embodiment, the at least one thinner component includes methyl ethyl ketone.

In another embodiment, the at least one thinner component is present in the amount of 1% to 5% by volume of the composition.

In another embodiment, the at least one protective component includes polyurethane.

In another embodiment, the at least one protective component is present in the amount of 90% to 98% by volume of the composition.

In another embodiment, the composition further includes 0.1% to 25% by volume of at least one drying component.

In another embodiment, the at least one drying component includes Japan drier.

In another embodiment, the at least one drying component is present in the amount of 0.1% to 5% by volume of the composition.

In another embodiment, the composition further includes 0.1% to 15% by volume of at least one coloring component.

In another embodiment, the at least one coloring component includes a mixture of liquid dye and vinegar.

In another embodiment, the at least one coloring component includes a mixture of powder and vinegar.

In another embodiment, the at least one coloring component is present in the amount of 0.1% to 5% by volume of the composition.

In another embodiment, the composition further includes 1% to 30% by volume of at least one paint reducer component.

In another embodiment, the composition further includes 0.1% to 50% by volume of at least one dispersant component.

In another embodiment, the composition further includes 1% to 35% by volume of at least one oil component.

In another embodiment, a method for repairing and protecting a polymeric surface includes: applying the composition of any one of claims 19 to 33 to the polymeric surface; and allowing the composition to dry for a period of 15 seconds to 24 hours.

In another embodiment, the polymeric surface is an automotive polymeric surface.

In another embodiment, the step of applying includes applying the composition to a cloth, pad, sponge, scrub, foam brush, or t-shirt and using such on the polymeric surface.

In another embodiment, the polymeric surface includes polypropylene, high density polyethylene, polyvinyl chloride, low density polyethylene, polyurethane, polystyrene, acrylonitrile butadiene styrene, polybutylene terephthalate, polyoxymethylene, nylon, polyethylene terephthalate, polycarbonate, polyesters, or a mixture of two or more thereof.

In accordance with another aspect of the present disclosure, a polymeric surface repairer and protectant composition comprises, by weight of the composition: 50% to 95% of at least one thinner component; and 1% to 30% of at least one protective component.

In one embodiment, the at least one thinner component includes xylene.

In another embodiment, the at least one thinner component includes, by weight of the at least one thinner component: 50% to 85% of naphtha; 20% to 40% of xylene; 5% to 30% of methyl ethyl ketone.

In another embodiment, the at least one thinner component is present in the amount of 80% to 90% by weight of the composition.

In another embodiment, the at least one protective component includes acrylic polymer.

In another embodiment, the acrylic polymer includes ethyl methacrylate, methyl methacrylate, or a co-polymer of these monomers.

In another embodiment, the at least one protective component is present in the amount of 10% to 20% by weight of the composition. In another embodiment, the composition further includes 0.1% to 5% by weight of at least one surfactant component.

In another embodiment, the at least one surfactant component includes ethoxylated alcohols, alkyl phenols, commercial surfactants, or any mixture thereof.

In another embodiment, the composition further includes 0.1% to 15% by volume of at least one coloring component.

In another embodiment, the composition further includes 1% to 30% by volume of at least one paint reducer component.

In another embodiment, the composition further includes 0.1% to 50% by volume of at least one dispersant. In another embodiment, the composition further includes 0.1% to 5% by volume of at least one drying component.

In another embodiment, the composition further includes 1% to 35% by volume of at least one oil component.

In another embodiment, a method for repairing and protecting a polymeric surface includes: applying the composition of any one of claims 38 to 51 to the polymeric surface; and allowing the composition to dry for a period of 15 seconds to 24 hours.

In another embodiment, the polymeric surface is an automotive polymeric surface.

In another embodiment, the step of applying includes applying the composition to a cloth, pad, sponge, scrub, or foam brush, and using such on the polymeric surface.

In another embodiment, the polymeric surface includes polypropylene, high density polyethylene, polyvinyl chloride, low density polyethylene, polyurethane, polystyrene, acrylonitrile butadiene styrene, polybutylene terephthalate, polyoxymethylene, nylon, polyethylene terephthalate, polycarbonate, polyesters, or a mixture of two or more thereof.

### DETAILED DESCRIPTION

In the description that follows, features that are described with respect to one embodiment may be used in the same way or in a similar way in one or more other embodiments and/or in combination with or instead of the features of the other embodiments.

The present disclosure provides a polymeric surface repairer and protectant composition for restoring faded and worn polymeric surfaces. In contrast with conventional polymeric surface restoration products that may simply coat a faded/worn polymeric surface, the polymeric surface repairer and protectant composition of the present disclosure may etch the polymeric surface so that one or more of the components of the composition may bind thereto and/or become impregnated therein. As used herein, the term “surface” refers to the outermost part of the polymeric material to include cracks, crevices, and crazing, and any newly revealed portions of the polymeric material exposed by etching. As used herein, the term “etch” or “etching” refers to melting the polymeric surface, creating minute cracks (i.e., crazing) on the polymeric surface, dissolving the polymeric surface such that the polymeric surface dissolves into the applied composition, a chemical reaction with the polymeric surface, or a combination thereof. Additionally, the polymeric surface repairer and protectant composition of the present disclosure may provide superior performance in multiple climate conditions (e.g., driving rain, snow, extreme ultraviolet radiation, extreme heat and cold, extreme humidity and dryness). The polymeric surface repairer and protectant composition may thereby provide long lasting shine, coloring, and protection. Unlike conventional restoration products, since the composition of the present disclosure maintains a restored polymeric surface finish for an extended period of time (e.g., two months to one year), the composition may not require monthly re-applications. Moreover, the polymeric surface repairer and protectant composition may be non-destructive such that any flaws may be fixed with a re-application on top of the previous application. This property allows for the polymeric surface to be usable after an application and re-application of the disclosed composition may again yield a restored polymeric surface.

As described below, the polymeric surface repairer and protectant composition may be applied to a polymeric surface and allowed to dry for a period of time. One exemplary embodiment of a polymeric surface to which the polymeric surface repairer and protectant composition is applied is a polymeric surface used in an automotive application (e.g., automotive plastic). It will be appreciated that while the polymeric surface repairer and protectant composition of the present disclosure may have particular application to automotive polymeric surfaces (e.g., trim and/or light cover) repair and protection, the principles of the disclosure may be useful for any polymeric surface application where it is desirable to provide polymeric surface repair and protection.

The polymeric surface repairer and protectant composition of the present disclosure includes at least one thinner component and at least one protective component. The at least one thinner component may clean, etch the polymeric surface, and may alter or set drying time of the polymeric surface repairer and protectant composition. The at least one protective component may provide protection and a desired surface finish to the polymeric surface. In some embodiments, the polymeric surface repairer and protectant composition may further include at least one oil component. The at least one oil component may provide a desired sheen to the polymeric surface. In some embodiments, as an alternative to or in addition to the oil component, the polymeric surface repairer and protectant composition may include at least one drying component. The at least one drying component may alter drying time of the repair and protectant composition.

In some embodiments, the at least one thinner component may include acetates (e.g., ethyl acetate, methyl acetate, n-propyl acetate, n-butyl acetate, t-butyl acetate), esters (e.g., dimethyl carbonate), ethers (e.g., glycol), alcohols (e.g., butanol, propanol), ketones (e.g., methyl ethyl ketone, methyl isobutyl ketone, acetone), hydrocarbons (e.g., mineral spirits, turpentine, naphtha, petroleum naphtha, benzene, ethylbenzene, trimethyl benzene, cumene, toluene, xylene, kerosene, diesel fuel, petroleum), amides (e.g., dimethylformamide) or a mixture of two or more thereof. In some embodiments, the at least one thinner component may include polar aprotic solvents (e.g., acetone, ethyl acetate, methyl ethyl ketone), non-polar aprotic solvents (e.g., benzene, cumene, naphtha, trimethyl benzene, xylene isomers), or a mixture thereof. In one example, the at least one thinner component includes naphtha, xylene, and methyl ethyl ketone. In one example, the at least one thinner component is a paint thinner. An exemplary paint thinner is available from Klean-Strip® (Memphis, Tenn.) as Klean-Strip® Paint Thinner. The at least one thinner component may clean the polymeric surface to which the polymeric surface repairer and protectant composition is applied. The at least one thinner component may also etch the top layer of polymeric surface to which the polymeric surface repairer and protectant composition is applied, thereby creating minute cracks which are then impregnated by another component of the composition (e.g., the at least one protective component). This etching may occur as a result of a reaction between the polymeric surface and the at least one thinner component. Subsequent to etching, the at least one thinner component may alter or set drying time properties. For example, a higher amount of the at least one thinner component may shorten drying time, which may be a desired feature in an automotive polymeric surface application (e.g., allows for returning a car to a customer more quickly). The at least one thinner component may also even out the surface finish of the polymeric surface repairer and protectant composition. The at least one thinner component may be present in any suitable amount. In one example, the at least one thinner component may be present in the polymeric surface repairer and protectant composition from 1% to 75% by volume of the polymeric surface repairer and protectant composition, or in another example, 1% to 50% by volume of the polymeric surface repairer and protectant composition, or in another example, 1% to 25% by volume of the polymeric surface repairer and protectant composition, or in another example, 1% to 10% by volume of the polymeric surface repairer and protectant composition, or in another example, 1% to 5% by volume of the polymeric surface repairer and protectant composition, or in another example, 10% to 75% by volume of the polymeric surface repairer and protectant composition, or in another example, 25% to 75% by volume of the polymeric surface repairer and protectant composition, or in another example, 50% to 75% by volume of the polymeric surface repairer and protectant composition, or in another example, 10% to 25% by volume of the polymeric surface repairer and protectant composition, or in another example, 10% to 50% by volume of the polymeric surface repairer and protectant composition, or in another example, 10% to 55% by volume of the polymeric surface repairer and protectant composition, or in another example, 25% to 50% by volume of the polymeric surface repairer and protectant composition, or in another example, 35% to 55% by volume of the polymeric surface repairer and protectant composition, or in another example, 40% to 50% by volume of the polymeric surface repairer and protectant composition. In another example, the at least one thinner component may be present in the polymeric surface repairer and protectant composition from 25% to 95% by weight of the polymeric surface repairer and protectant composition, or in another example, 50% to 95% by weight of the polymeric surface repairer and protectant composition, or in another example, 75% to 95% by weight of the polymeric surface repairer and protectant composition, or in another example, 80% to 90% by weight of the polymeric surface repairer and protectant composition.

The at least one thinner component may include one or more compounds. In some embodiments, each compound may be present in the at least one thinner component from 1% to 95% by weight of the at least one thinner component, or in another example, 5% to 85% by weight of the at least one thinner component, or in another example, 10% to 75% by weight of the at least one thinner component, or in another example, 10% to 50% by weight of the at least one thinner component, or in another example, 5% to 30% by weight of the at least one thinner component, or in another example, 20% to 40% by weight of the at least one thinner component, or in another example, 25% to 95% by weight of the at least one thinner component, or in another example, 50% to 85% by weight of the at least one thinner component, or in another example, 50% to 75% by weight of the at least one thinner component.

In some embodiments, the at least one protective component may include acrylic polymer, urethane, polyurethane, lacquer, zinc oxide, or a mixture of two or more thereof. The acrylic polymer may include the monomers ethyl methacrylate, methyl methacrylate, or a co-polymer of these monomers. In one example, the molecular weight of the acrylic polymer may be in the range of 1,000 Dalton to 500,000 Dalton, or in another example, 5,000 Dalton to 400,000 Dalton, or in another example, 5,000 Dalton to 300,000 Dalton, or in another example, 7,500 Dalton to 300,000 Dalton, or in another example, 10,000 Dalton to 250,000 Dalton. In one example, the acrylic polymer has a polydispersity index between 1 and 20, or in another example, between 1 and 15, or in another example, between 1 and 10, or in another example, between 1 and 5. Acrylic polymer is available, for example, as Acryloid B-72, Acryloid B-67, Elvacite 2552C, Elvacite 2046, Neocryl A-693, Neocryl B-731, Dianal MB-7033, and Dianal MB-3015. Urethane or polyurethane components are available, for example, from Minwax® Company (Upper Saddle River, N.J.) as Minwax® Helmsman® Spar Urethane, Minwax® Fast-Drying Polyurethane Clear Gloss, and Minwax® Polycrylic™ Protective Finish. The at least one protective component may provide protection to the polymeric surface on which the polymeric surface repairer and protectant composition is applied, including UV, abrasion protection (e.g., protection against scars, scuffs, chips, or dents), and waterproofing. The at least one protective component may also provide the desired surface finish to the polymeric surface, such as matte, glossy, or satin. The at least one protective component may be present in any suitable amount. In one example, the at least one protective component may be present in the polymeric surface repairer and protectant composition from 1% to 99% by volume of the polymeric surface repairer and protectant composition, or in another example, 1% to 75% by volume of the polymeric surface repairer and protectant composition, or in another example, 1% to 50% by volume of the polymeric surface repairer and protectant composition, or in another example, 1% to 35% by volume of the polymeric surface repairer and protectant composition, or in another example, 1% to 30% by volume of the polymeric surface repairer and protectant composition, or in another example, 1% to 25% by volume of the polymeric surface repairer and protectant composition, or in another example, 10% to 35% by volume of the polymeric surface repairer and protectant composition, or in another example, 20% to 30% by volume of the polymeric surface repairer and protectant composition, or in another example, 50% to 98% by volume of the polymeric surface repairer and protectant composition, or in another example, 75% to 98% by volume of the polymeric surface repairer and protectant composition, or in another example, 90% to 98% by volume of the polymeric surface repairer and protectant composition. In another example, the at least one protective component may be present in the polymeric surface repairer and protectant composition from 1% to 25% by weight of the polymeric surface repairer and protectant composition, or in another example, 1% to 20% by weight of the polymeric surface repairer and protectant composition, or in another example, 5% to 25% by weight of the polymeric surface repairer and protectant composition, or in another example, 10% to 25% by weight of the polymeric surface repairer and protectant composition, or in another example, 10% to 20% by weight of the polymeric surface repairer and protectant composition, or in another example, 10% to 15% by weight of the of the polymeric surface repairer and protectant composition.

In some embodiments, the polymeric surface repairer and protectant composition may include at least one oil component. The at least one oil component may include mineral oil, natural oil, or a mixture thereof. As used herein, the term “mineral oil” is an oil composed mainly of cyclic paraffins and/or alkanes, wherein the cyclic paraffins and/or alkanes are formed of carbon chains having 10-50 carbons. The mineral oil may be transparent and colorless. The mineral oil may include paraffinic oils that are based on n-alkanes, naphthenic oils that are based on cycloalkanes, aromatic oils that are based on aromatic hydrocarbons, or a mixture of two or more thereof. The mineral oil may include natural ester oils, fish oils, various hydro-carbon-based saturated or unsaturated compounds, or a mixture of two or more thereof. As used herein, the term “natural oil” refers to organic oils that are produced by plants, animals, and other organisms through organic processes. Natural oils may include vegetable oils, essential oils, tallow, other lipids, or a mixture of two or more thereof. The vegetable oil may include linseed oil, boiled linseed oil, coconut oil, corn oil, cottonseed oil, olive oil, palm oil, peanut oil, rapeseed oil, canola oil, safflower oil, sesame oil, soybean oil, sunflower oil, other suitable vegetable, grain, and nut oils, or a mixture of two or more thereof. An exemplary vegetable oil is available from Klean-Strip® (Memphis, Tenn.) as Klean-Strip® Boiled Linseed Oil. The at least one oil component may provide a desired sheen on the polymeric surface to which the polymeric surface repairer and protectant composition is applied. The at least one oil component may be present in any suitable amount. In one example, the at least one oil component may be present in the polymeric surface repairer and protectant composition from 1% to 50% by volume of the polymeric surface repairer and protectant composition, or in another example, 1% to 35% by volume of the polymeric surface repairer and protectant composition, or in another example, 1% to 25% by volume of the polymeric surface repairer and protectant composition, or in another example, 1% to 10% by volume of the polymeric surface repairer and protectant composition, or in another example, 10% to 35% by volume of the polymeric surface repairer and protectant composition, or in another example, 25% to 35% by volume of the polymeric surface repairer and protectant composition.

In some embodiments, the polymeric surface repairer and protectant composition may include at least one drying component. The at least one drying component may include Japan drier. As used herein, the term “drying component” refers to a component that shortens the drying time of oil, enamel, and varnish. An exemplary Japan drier is available from Klean-Strip® (Memphis, Tenn.) as Klean-Strip® Japan Drier. The at least one drying component may alter drying time properties. The at least one drying component may be present in any suitable amount. In one example, the at least one drying component may be present in the polymeric surface repairer and protectant composition 0% to 25% by volume of the polymeric surface repairer and protectant composition, or in another example, 0.1% to 25% by volume of the polymeric surface repairer and protectant composition, or in another example, 1% to 25% by volume of the polymeric surface repairer and protectant composition, or in another example, 0% to 10% by volume of the polymeric surface repairer and protectant composition, or in another example, 0.1 to 10% by volume of the polymeric surface repairer and protectant composition, or in another example, 1% to 10% by volume of the polymeric surface repairer and protectant composition, or in another example, 0% to 5% by volume of the polymeric surface repairer and protectant composition, or in another example, 0.1% to 5% by volume of the polymeric surface repairer and protectant composition, or in another example, 1% to 5% by volume of the polymeric surface repairer and protectant composition.

In some embodiments, the polymeric surface repairer and protectant composition may include at least one coloring component. The at least one coloring component may include one or more pigments, dyes, and colorants. Exemplary pigments and dyes are available from Nakoma Products LLC (Bridgeview, Ill.) as Rit Liquid Dye and Rit Powder Dye. In one example, the at least one coloring component may include a mixture of Rit Liquid Dye and a fixative such as vinegar, and in another example, a mixture of Rit Powder Dye and a fixative such as vinegar. In one example, a mixture of Rit Liquid Dye and a fixative would contain twice as much volume as a mixture of Rit Powder Dye and a fixative, even if the fixative volume remains constant. The at least one coloring component may provide color to the polymeric surface on which the polymeric surface repairer and protectant composition is applied. The at least one coloring component may be present in any suitable amount. In one example, the at least one coloring component may be present in the polymeric surface repairer and protectant composition from 0% to 25% by volume of the polymeric surface repairer and protectant composition, or in another example, 0.1% to 25% by volume of the polymeric surface repairer and protectant composition, or in another example, 1% to 25% by volume of the polymeric surface repairer and protectant composition, or in another example, 0% to 15% by volume of the polymeric surface repairer and protectant composition, or in another example, 0.1% to 15% by volume of the polymeric surface repairer and protectant composition, or in another example, 1% to 15% by volume of the polymeric surface repairer and protectant composition, or in another example, 0% to 10% by volume of the polymeric surface repairer and protectant composition, or in another example, 0.1% to 10% by volume of the polymeric surface repairer and protectant composition, or in another example, 1% to 10% by volume of the polymeric surface repairer and protectant composition, or in another example, 0% to 5% by volume of the polymeric surface repairer and protectant composition, or in another example, 0.1% to 5% by volume of the polymeric surface repairer and protectant composition, or in another example, 1% to 5% by volume of the polymeric surface repairer and protectant composition.

In some embodiments, the polymeric surface repairer and protectant composition may include at least one paint reducer component. The at least one paint reducer component may include a urethane reducer. An exemplary urethane reducer is available from Grow Automotive (Detroit, Mich.) as Grow Automotive Urethane Reducer. The at least one paint reducer component may help extend the polymeric surface repairer and protectant composition so less is needed upon application. The at least one paint reducer component may also enhance the surface finish of the polymeric surface repairer and protectant composition so that a more uniform look is achieved. The at least one paint reducer component may be present in any suitable amount. In one example, the at least one paint reducer component may be present in the polymeric surface repairer and protectant composition from 0% to 75% by volume of the polymeric surface repairer and protectant composition, or in another example, 1% to 75% by volume of the polymeric surface repairer and protectant composition, or in another example, 0% to 50% by volume of the polymeric surface repairer and protectant composition, or in another example, 1% to 50% by volume of the polymeric surface repairer and protectant composition, or in another example, 0% to 25% by volume of the polymeric surface repairer and protectant composition, or in another example, 1% to 25% by volume of the polymeric surface repairer and protectant composition, or in another example, 0% to 10% by volume of the polymeric surface repairer and protectant composition, or in another example, 1% to 10% by volume of the polymeric surface repairer and protectant composition, or in another example, 1% to 30% by volume of the polymeric surface repairer and protectant composition, or in another example, 10% to 25% by volume of the polymeric surface repairer and protectant composition, or in another example, 10% to 30% by volume of the polymeric surface repairer and protectant composition, or in another example, 20% to 40% by volume of the polymeric surface repairer and protectant composition, or in another example, 20% to 30% by volume of the polymeric surface repairer and protectant composition. In a preferred embodiment, the paint reducer component is present in the polymeric surface repairer and protectant composition in 25% by volume of the polymeric surface repairer and protectant composition.

In some embodiments, the polymeric surface repairer and protectant composition may include at least one dispersant component. The at least one dispersant component may include acetone, propane, butane, or a mixture of two or more thereof. Exemplary dispersant components are available from SEM® (Rock Hill, S.C.) as Custom Fill™ Aerosol Blanks and SEM® 61993. In some embodiments, the at least one dispersant component may promote mixing of the components of the repairer and protectant composition. In some embodiments, the at least one dispersant component may be used to adjust the viscosity, which results from the improved dispersion of particles, or one or more other physical properties of the repairer and protectant composition so that the composition can be used in a suitable application. As an example, inclusion of the at least one dispersant may allow the polymeric surface repairer and protectant composition to be applied to the polymeric surface in the form of a spray. The at least one dispersant component may be present in any suitable amount. In one example, the at least one dispersant component may be present in the polymeric surface repairer and protectant composition from 0% to 75% by volume of the polymeric surface repairer and protectant composition, or in another example, 0.1% to 75% by volume of the polymeric surface repairer and protectant composition, or in another example, 1% to 75% by volume of the polymeric surface repairer and protectant composition, or in another example, 0% to 50% by volume of the polymeric surface repairer and protectant composition, or in another example, 0.1% to 50% by volume of the polymeric surface repairer and protectant composition, or in another example, 1% to 50% by volume of the polymeric surface repairer and protectant composition, or in another example, 0% to 25% by volume of the polymeric surface repairer and protectant composition, or in another example, 0.1% to 25% by volume of the polymeric surface repairer and protectant composition, or in another example, 1% to 25% by volume of the polymeric surface repairer and protectant composition, or in another example, 0% to 10% by volume of the polymeric surface repairer and protectant composition, or in another example, 0.1% to 10% by volume of the polymeric surface repairer and protectant composition, or in another example, 0.1% to 30% by volume of the polymeric surface repairer and protectant composition, or in another example, 1% to 10% by volume of the polymeric surface repairer and protectant composition, or in another example, 10% to 25% by volume of the polymeric surface repairer and protectant composition, or in another example, 20% to 30% by volume of the polymeric surface repairer and protectant composition. In a preferred embodiment, the dispersant component is present in the polymeric surface repairer and protectant composition in 25% by volume of the polymeric surface repairer and protectant composition.

In some embodiments, the polymeric surface repairer and protectant composition may include at least one surfactant component. The at least one surfactant component may include, but is not limited to, a non-ionic amphiphilic surfactant such as ethoxylated alcohols (e.g., decanol ethoxylate or lauryl alcohol ethoxylate), alkyl phenols (e.g., p-decylphenol, p-dodecylphenol), commercial surfactants, or any mixture thereof. Surfactant components are available, for example, as Triton™ X-100 and IGEPAL® CA-630. In some embodiments, the at least one surfactant component may be used to adjust the surface tension or one or more other physical properties of the repairer and protectant composition so that the composition can be used in a suitable application. In some embodiments, the at least one surfactant component may promote mixing of the components of the repairer and protectant composition. In one example, the at least one surfactant component may be present in the polymeric surface repairer and protectant composition from 0% to 10% by weight of the polymeric surface repairer and protectant composition, or in another example, 0.1% to 10% by weight of the polymeric surface repairer and protectant composition, or in another example, 0.1% to 5% by weight of the polymeric surface repairer and protectant composition, or in another example, 0.1% to 1% by weight of the polymeric surface repairer and protectant composition, or in another example, 0.5% to 10% by weight of the polymeric surface repairer and protectant composition, or in another example, 0.5% to 5% by weight of the polymeric surface repairer and protectant composition, or in another example, 0.5% to 5% by weight of the polymeric surface repairer and protectant composition, or in another example, 1% to 10% by weight of the polymeric surface repairer and protectant composition, or in another example, 1% to 5% by weight of the polymeric surface repairer and protectant composition.

The polymeric surface repairer and protectant composition of the present disclosure may be formulated to clean, repair, recolor, and reseal polymeric surfaces. The polymeric surface repairer and protectant composition may provide long lasting shine, coloring, and protection. In some embodiments, dirt or debris may be removed from the polymeric surface upon application of the polymeric surface repairer and protectant composition. Accordingly, this may eliminate the extra step of cleaning the polymeric surface generally required before applying a conventional composition. Once applied to the polymeric surface, the polymeric surface repairer and protectant composition may react with the polymeric surface to etch the polymeric surface. This etching may be caused by the thinner component of the polymeric surface repairer and protectant composition. Upon etching, other components (e.g., the protective component and one or more of the other components such as the at least one coloring component) may become embedded therein to the polymeric surface and any newly formed voids in the surface. During a period of time (e.g. drying period), the thinner component and other components (e.g., the at least one drying component) may be removed via drying. Any remaining components, including components that were dissolved in the composition, may adhere (e.g., bind, become intimately coated, become impregnated) to the etched surface, dry to solid form, and become embedded therein. The polymeric surface may reset (e.g. reseal, reharden or assume a solidified form) and may encapsulate the polymeric surface repairer and protectant composition and any dissolved components of the polymeric surface.

The adherence and embedding of the polymeric surface repairer and protectant composition to the polymeric surface may lead to durability (e.g., prevent flaking) and may provide a long-lasting gloss and/or shine to the polymeric surface. The thermal expansion and contraction of the polymeric surface repairer and protectant composition may be similar to or equal to the thermal expansion and contraction of the polymeric surface, which may lead to durability and prevent shearing of the polymeric surface. In other embodiments, the polymeric surface may require pretreatment (e.g., cleaning) before application of the polymeric surface repairer and protectant composition such that the polymeric surface repairer and protectant composition repairs, recolors, and reseals polymeric surfaces. In other embodiments, the polymeric surface repairer and protectant composition may be formulated to repair and reseal polymeric surfaces.

As used herein, the term “drying period” refers to the time in which the polymeric surface dries to the touch. In one example, the drying period may be in the range of 15 seconds to 24 hours, or in another example, 1 minute to 24 hours, or in another example, 1 minute to 12 hours, or in another example, 1 minute to 6 hours, or in another example, 1 minute to 3 hours, or in another example 1 minute to 1 hour, or in another example, 15 seconds to 30 minutes. The polymeric surface may fully cure (e.g., curing period) after the drying period. In one example, the curing period may be in the range of 12 hours to 7 days, or in another example, 12 hours to 3 days, or in another example, 12 hours to 24 hours.

The polymeric surface repairer and protectant composition may be applied to the polymeric surface to be treated in a number of ways, such as pouring the polymeric surface repairer and protectant composition directly onto the polymeric surface; applying the polymeric surface repairer and protectant composition to a cloth, pad, sponge, scrub, foam brush, or the like and then using such on the polymeric surface; or pre-loading the polymeric surface repairer and protectant composition on a wipe and using the pre-loaded wipe on the polymeric surface. The polymeric surface repairer and protectant composition may be in the form of a liquid, gel, paste, or spray. The particular form of the polymeric surface repairer and protectant composition may depend, for example, on the particular dispersant(s) used in the composition, as well as the types and amounts of the other components utilized in the composition.

In some embodiments, the polymeric surface repairer and protectant composition may be applied to polymeric surfaces such as plastics including polypropylene (PP), high density polyethylene (HDPE), polyvinyl chloride (PVC), low density polyethylene (LDPE), polyurethane, polystyrene, acrylonitrile butadiene styrene (ABS resin), polybutylene terephthalate (PBT), polyoxymethylene (POM), nylon, polyethylene terephthalate (PET), polycarbonate (PC), polyesters, or a mixture of two or more thereof. In some embodiments, the polymeric surface repairer and protectant composition may primarily adhere to polymeric surfaces, not clear coats and paints. Accordingly, if the polymeric surface repairer and protectant composition is accidentally applied to the paint of a car while applying the protect composition to the automotive trim, the polymeric surface repairer and protectant composition may be easily removed from the paint. The prevention of adherence to coats and paints may be controlled by the amount of the at least one thinner component in the polymeric surface repairer and protectant composition. For example, the at least one thinner component may alter drying time of the polymeric surface repairer and protectant composition. Accordingly, a lower amount of thinner component may lengthen drying time so that the polymeric surface repairer and protectant composition may be removed from the paint before it dries.

In addition to being applicable to automotive trim (e.g., bumper), the polymeric surface repairer and protectant composition may be applied to automotive transparent polymeric surfaces (e.g., headlights and taillights). The polymeric surface repairer and protectant composition may restore a faded transparent polymeric surface back to partial or full transparency. In some embodiments, the restored polymeric surface has a similar refractive index as transparent polymeric surfaces (e.g., headlights and taillights) and permits a light to transmit through the surface in a pattern similar to the original polymeric surface (e.g., after manufacturing of headlight or taillight). The polymeric surface repairer and protectant composition may also fix scaring or scratches of the transparent polymeric surface to improve transparency by etching the polymeric surface such that the composition is embedded in the scaring or scratches. The polymeric surface repairer and protectant composition may remove the appearance of such scratches. Conventional products require wet sanding after application to a transparent polymeric surface, which necessitates protective gear and more time than the application of the repairer and protectant composition of the present disclosure. By contrast, in some embodiments, the polymeric surface repairer and protectant composition of the present disclosure may be applied and allowed to dry without the need for any further steps.

In some embodiments, the polymeric surface repairer and protectant composition may be formulated to be safely applied without emitting any odors, fumes, vapors or toxins such that venting is not required. The polymeric surface repairer and protectant composition may be formulated to be free of volatile organic compounds and harmful chemical secretions such that safety apparel (e.g., gloves) is not required during application of the polymeric surface repairer and protectant composition.

In some embodiments, the process for making the polymeric surface repairer and protectant composition may include at least one mixing step. In one example, the at least one thinner component and the at least one protective component may be mixed to produce the repairer and protectant composition. In some embodiments, the process for making the polymeric surface repairer and protectant composition may include combining a first mixture including one or more components with a second mixture including one or more components to yield the polymeric surface repairer and protectant composition. In one example, the at least one thinner component is mixed with an oil component to form a first mixture, the at least one protective component and at least one coloring component are mixed to form a second mixture, and the first and second mixture are mixed to yield the polymeric surface repairer and protectant composition. In some embodiments, the process for making the polymeric surface repairer and protectant composition may include a step-wise addition of separate components. In one example, the at least one thinner component is mixed with the protective component to form a first mixture, the first mixture is mixed with a drying component to form a second mixture, and the second mixture is mixed with a coloring component to yield the polymeric surface repairer and protectant composition.

### EXAMPLES

Example 1—Making coloring component comprised of Rit Liquid Dye and vinegar. One part by volume of Rit Liquid Dye is mixed with one part by volume vinegar to produce a coloring component.

Example 2—Making coloring component including Rit Powder Dye and vinegar. 0.4±20% grams of Rit Powder Dye is mixed with 0.25 mL±15% vinegar to produce a coloring component.

Example 3—First exemplary polymeric surface repairer and protectant composition. The following table shows the components A through D of a first exemplary polymeric surface repairer and protectant composition:

| | Total mixture | Minimum | Maximum |
|---|---|---|---|
| Components | ratios by volume | amount | amount |
| A - Paint thinner | 42% | 14% | 54.6% |
| B - Boiled linseed oil | 28% | 3% | 30.8% |
| C - Minwax ® Helmsman ® | 25% | 3% | 27.5% |
| Spar Urethane | | | |
| D - Coloring component | 5% | 0% | 15% |

The first exemplary polymeric surface repairer and protectant composition is made by mixing components A and B to yield an AB mixture, mixing components C and D to yield a CD mixture, and mixing the AB mixture and the CD mixture to yield the first exemplary polymeric surface repairer and protectant composition.

Example 4—Second exemplary polymeric surface repairer and protectant composition. The following table shows components A through D of a second exemplary polymeric surface repairer and protectant composition.

| | Total mixture | Minimum | Maximum |
|---|---|---|---|
| Components | ratios by volume | amount | amount |
| A - Methyl ethyl ketone | 3% | 2% | 4.8% |
| B - Minwax ® Fast-Drying | 95% | 80% | 97% |
| Polyurethane Clear Gloss | | | |
| C - Japan drier | 2% | 0% | 2.8% |
| D - Coloring component | 0.14% | 0% | 15% |

The second exemplary polymeric surface repairer and protectant composition is made by mixing components A and B to yield an AB mixture, mixing the AB mixture with the C component to yield an ABC mixture, and mixing the ABC mixture with the D component to yield the second exemplary polymeric surface repairer and protectant composition.

Example 5—Third exemplary polymeric surface repairer and protectant composition. The following table shows components A and B of a third exemplary polymeric surface repairer protectant composition.

| | Total mixture | Minimum | Maximum |
|---|---|---|---|
| Components | ratios by weight | amount | amount |
| A - Acrylic polymer | 13% | 5% | 25% |
| B - Xylene | 87% | 75% | 95% |

The third exemplary polymeric surface repairer and protectant composition is made by mixing components A and B until A dissolves in B to yield the third exemplary polymeric surface repairer and protectant composition.

Example 6—Fourth exemplary polymeric surface repairer and protectant composition. The following table shows components A, B, and C of a fourth exemplary polymeric surface repairer protectant composition.

| | Total mixture | Minimum | Maximum |
|---|---|---|---|
| Components | ratios by weight | amount | amount |
| A - Acrylic polymer | 13% | 5% | 25% |
| B - Thinner component | 87% | 75% | 95% |
| C - Surfactant | <1% | 0.1% | 5% |

The following table shows the individual compounds of Component B—Thinner component.

| | Minimum | Maximum |
|---|---|---|
| | amount | amount |
| Components | by weight | by weight |
| Naphtha | 50% | 85% |
| Xylene isomers | 20% | 40% |
| Methyl ethyl ketone | 5% | 30% |

Although the invention has been shown and described with respect to a certain embodiment or embodiments, it is obvious that equivalent alterations and modifications will occur to others skilled in the art upon the reading and understanding of this specification. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein described exemplary embodiment or embodiments of the invention. In addition, while a particular feature of the invention may have been described above with respect to only one or more of several described embodiments, such features may be combined with one or more other features of the other embodiments, as may be desired and advantageous for any given or particular application.

1.-55. (canceled)

56. A polymeric surface application composition comprising, by volume of the composition:
10% to 55% of at least one thinner component;
1% to 35% of at least one oil; and
1% to 30% of at least one protective component.

57. The polymeric surface application composition of claim 56, wherein the at least one thinner component comprises mineral spirits.

58. The polymeric surface application composition of claim 56, wherein the at least one oil comprises natural oil.

59. The polymeric surface application composition of claim 56, wherein the at least one protective component comprises at least one of an acrylic polymer, urethane, polyurethane, or mixture thereof.

60. The polymeric surface application composition of claim 56, further comprising 1% to 30% by volume of at least one paint reducer.

61. The polymeric surface application composition of claim 56, further comprising 0.1% to 5% by volume of at least one drying component.

62. The polymeric surface application composition of claim 56, wherein the composition etches polymeric surfaces.

63. A polymeric surface application composition comprising, by volume of the composition:
1% to 25% of at least one thinner component; and
50% to 98% of at least one protective component.

64. The polymeric surface application composition of claim 63, wherein the at least one thinner component comprises one or more ketones.

65. The polymeric surface application composition of claim 63, wherein the at least one protective component comprises at least one of an acrylic polymer, urethane, polyurethane, or mixture thereof.

66. The polymeric surface application composition of claim 63, further comprising 0.1% to 25% by volume of at least one drying component.

67. The polymeric surface application composition of claim 63, further comprising 1% to 30% by volume of at least one paint reducer.

68. The polymeric surface application composition of claim 63, wherein the composition etches polymeric surfaces.

69. A polymeric surface application composition comprising, by weight of the composition:
50% to 95% of at least one thinner component; and
1% to 30% of at least one protective component.

70. The polymeric surface application composition of claim 69, wherein the at least one thinner component comprises xylene.

71. The polymeric surface application composition of claim 69, wherein the at least one protective component comprises at least one of an acrylic polymer, urethane, polyurethane, or mixture thereof.

72. The polymeric surface application composition of claim 69, further comprising 0.1% to 5% by weight of at least one surfactant.

73. The polymeric surface application composition of claim 69, further comprising 1% to 30% by volume of at least one paint reducer.

74. The polymeric surface application composition of claim 69, further comprising 0.1% to 50% by volume of at least one dispersant.

75. The polymeric surface application composition of claim 69, wherein the composition etches polymeric surfaces.
